(19) United States
(12) Patent Application Publication
(10) Pub. No.: US 2013/0124218 A1
(43) Pub. Date: May 16, 2013

(54) SOCIAL ENGAGEMENT ENGINE FOR HEALTH WELLNESS PROGRAM

(71) Applicant: RedBrick Health Corporation, Minneapolis, MN (US)

(72) Inventors: Wendy Masloski, Champlin, MN (US); Eric Zimmerman, San Anselmo, CA (US)

(73) Assignee: RedBrick Health Corporation, Minneapolis, MN (US)

(21) Appl. No.: 13/645,719

(22) Filed: Oct. 5, 2012

Related U.S. Application Data
(60) Provisional application No. 61/544,901, filed on Oct. 7, 2011.

(51) Int. Cl. G06F 19/00

(52) U.S. Cl. 705/2

(57) ABSTRACT

The present disclosure generally relates to systems and methods to encourage health care consumers to engage in healthy lifestyle choices, thereby improving their overall health condition. More particularly, the present disclosure relates to using social media, via a social engagement engine, to encourage health care consumers to participate in health-improving activities and to engage in health-conscious behaviors. Specifically, disclosed is a computer-implemented system for operating a health program, which includes: a team formation module configured to receive data representing the formation of a plurality of teams; a challenge module configured to receive data representing the formation of one or more challenges; a data tracking module configured to receive, over an electronic network, data representing a tracked health condition of a user; and a scoring module configured to apply an algorithm to the health condition data to convert it into a numerical score.

### FIELD OF THE DISCLOSURE

The present disclosure generally relates to systems and methods to encourage health care consumers to engage in healthy lifestyle choices, thereby improving their overall health condition. More particularly, the present disclosure relates to using social media, via a social engagement engine, to encourage health care consumers to participate in health-improving activities and to engage in health-conscious behaviors.

### BACKGROUND OF THE DISCLOSURE

Unpredictable costs, unhealthy behavior, lost productivity, lack of personalized service, and disjointed health management programs continue to characterize the healthcare marketplace. For employers, the cost of providing healthcare has become staggering—over $9,600 annually per employee for larger organizations. About 50-70% of healthcare costs are directly related to discretionary and modifiable individual behavior. For most people, however, learning about and adopting healthier behaviors can require considerable and sometimes daunting amounts of internal motivation. Current health plans do little to help, providing little encouragement or incentive for individual change. For instance, an equitable financing structure remains absent from most health plans, unlike most other forms of insurance such as auto or home, where adopting less risky behavior may reduce premiums. Thus, individuals in group plans that choose not to take better care of their health are in effect subsidized by those that do, solidifying an unfair and unbalanced culture that lacks motivation and positive enforcement for improved health, and thus, fails to effectively manage healthcare costs.

Various “social media” platforms, which are typically provided to users thereof in the form of internet websites, are well known in the art. Social media websites provide a forum for users to display personal information about themselves, view personal information from other users, and interact with other users in a variety of manners. Popular social media websites include Facebook™, MySpace™, LinkedIn™, Twitter™, ASmallWorld™, Bebo™, Cyworld™, Diaspora™, Hi5™, Hyves™, Ning™, Orkut™, Plaxo™, Tagged™, XING™, and IRC™, etc.

Social media may broadly be understood as the use of web-based and mobile technologies to turn communication into interactive dialogue. Social media platforms use highly accessible and scalable communication techniques. Social media has the capability to reach small or large audiences. Social media can also allow communication virtually instantaneously.

Social media now accounts for 22% of all time spent online in the United States. A total of 234 million people age 13 and older in the U.S. used mobile devices in December 2009. Over 25% of U.S. internet page views occurred at one of the top social networking sites in December 2009, up from 13.8% a year before. The number of social media users age 65 and older grew 100 percent throughout 2010, so that one in four people in that age group are now part of a social networking site.

Thus, there is a need in the art for systems and methods that harness the power and relative ubiquity of social media and social engagement to encourage and incentivize health care consumers to adopt habits and behaviors that promote overall personal healthiness and wellness, thereby reducing healthcare costs.

### BRIEF SUMMARY OF THE DISCLOSURE

In one embodiment, disclosed herein is a computer-implemented method for operating a health program, which may include providing a computing system including a processor, a data storage medium, and software, wherein the software may cause the computing system to form a plurality of virtual teams based on team formation data stored in the data storage medium and form one or more virtual challenges based on challenge formation data stored in the data storage medium. A user may compete as a member of at least one of the plurality of virtual teams in the one or more virtual challenges by sending data representing a tracked health condition of the user over an electronic network to the computing system.

In another embodiment, disclosed herein is a computer-implemented system for operating a health program, which may include a processor configured to implement a team formation module configured to receive data representing the formation of a plurality of teams and store such data in a data storage medium operably connected to the processor, a challenge module configured to receive data representing the formation of one or more challenges and store such data in the data storage medium, a data tracking module configured to receive, over an electronic network, data representing a tracked health condition of a user and store such data in the data storage medium, and a scoring module configured to apply an algorithm to the health condition data to convert it into a numerical score.

In yet another embodiment, disclosed herein is a computer readable medium, which may include computer-executable instructions configured to cause a computer to form a plurality of virtual teams based on team formation data stored in the data storage medium and form one or more virtual challenges based on challenge formation data stored in the data storage medium. A user may compete as a member of at least one of the plurality of virtual teams in the one or more virtual challenges by sending data representing a tracked health condition of the user over an electronic network to the computing system.

While multiple embodiments are disclosed, including variations thereof, still other embodiments of the present disclosure will become apparent to those skilled in the art from the following detailed description, which shows and describes illustrative embodiments of the disclosure. As will be realized, the disclosure is capable of modifications in various obvious aspects, all without departing from the spirit and scope of the present disclosure. Accordingly, the drawings and detailed description are to be regarded as illustrative in nature and not restrictive.

### BRIEF DESCRIPTION OF THE FIGURES

While the specification concludes with claims particularly pointing out and distinctly claiming the subject matter that is regarded as forming the present disclosure, it is believed that the disclosure will be better understood from the following description taken in conjunction with the accompanying Figures, in which:

FIG. 1a depicts the interrelationships between the parties-at-interest using a social engagement engine in accordance with the present disclosure.

FIG. 1b depicts a computer-implemented system suitable for use with embodiments of the present disclosure.

FIG. 2a is a depiction of an example home page of a social engagement engine in accordance with the present disclosure.

FIG. 2b is a depiction of an example team selection module of a social engagement engine in accordance with the present disclosure.

FIG. 2c is a depiction of an example team information module of a social engagement engine in accordance with the present disclosure.

FIG. 2d is a depiction of an example team invitation electronic message produced by a social engagement engine in accordance with the present disclosure.

FIG. 2e is a depiction of an example weight tracking module of a social engagement engine in accordance with the present disclosure.

FIG. 2f is a depiction of an example activity tracking module of a social engagement engine in accordance with the present disclosure.

FIG. 2g is a depiction of an example nutrition tracking module of a social engagement engine in accordance with the present disclosure.

FIG. 2h is a depiction of an example leaderboard module of a social engagement engine in accordance with the present disclosure.

FIG. 3 depicts a flow diagram of method of use of the social engagement engine in accordance with the present disclosure.

### DETAILED DESCRIPTION

The present disclosure relates to a novel and advantageous system and method for harnessing the power of social media to improve the overall health and wellness of health care consumers. In one embodiment, the presently disclosed systems and methods employ a social engagement engine as the platform on which to provide an interactive and engaging experience for health care consumers seeking to improve their overall health condition. A social engagement engine in accordance with the present disclosure may employ a plurality of modules that interact in various respects with health care consumers. In some embodiments, modules may include, for example: a team formation module, wherein health care consumers may use the social engagement engine to form one or more teams to engage in one or more health-related “challenges” to improve selected health conditions; an invitation module, wherein health care consumers may use the social engagement engine as a platform to invite other persons who do not currently use the engine or are part of another team to join a team (or teams), thereby encouraging such persons to improve their health condition in a socially engaging manner; one or more health condition tracking modules, wherein health care consumers may use the social engagement engine to track qualitative or quantitative statistics regarding one or more health conditions, including but not limited to, for example, weight, nutrition, and exercise, etc; one or more challenge modules, wherein health care consumers may use the social engagement engine to design and engage in various forms of health-related challenges. As previously mentioned, health care consumers can engage in such challenges on a team basis, or alternatively, on an individual basis. The health condition tracking modules may be used in association with the challenges modules, wherein the statistics tracked by the tracking modules may be used as the basis for scoring the challenges. Modules may also include a scoring module, wherein health care consumers use the social engagement engine to follow the progress of one or more teams or individuals throughout the course of a challenge, the scoring module being configured to show, among other things, for example, current scores in the challenges (based on the application of one or more algorithms, as will be discussed in greater detail below), leaders or leading teams in the challenges, in ranked order, and time remaining in the challenge. The details of the aforementioned modules, in additional to other modules of the social engagement engine will be discussed in greater detail below. Thus, it will be appreciated that the interrelationship and interaction between the various modules of the presently described social engagement engine the health care consumers (or teams of health care consumers) serves to create an interactive and engaging social environment (or social “network”), wherein a goal is to promote the overall health of the users thereof by encouraging healthy lifestyle choices.

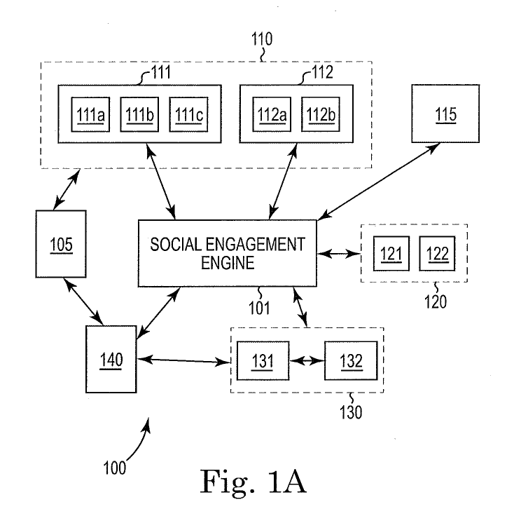

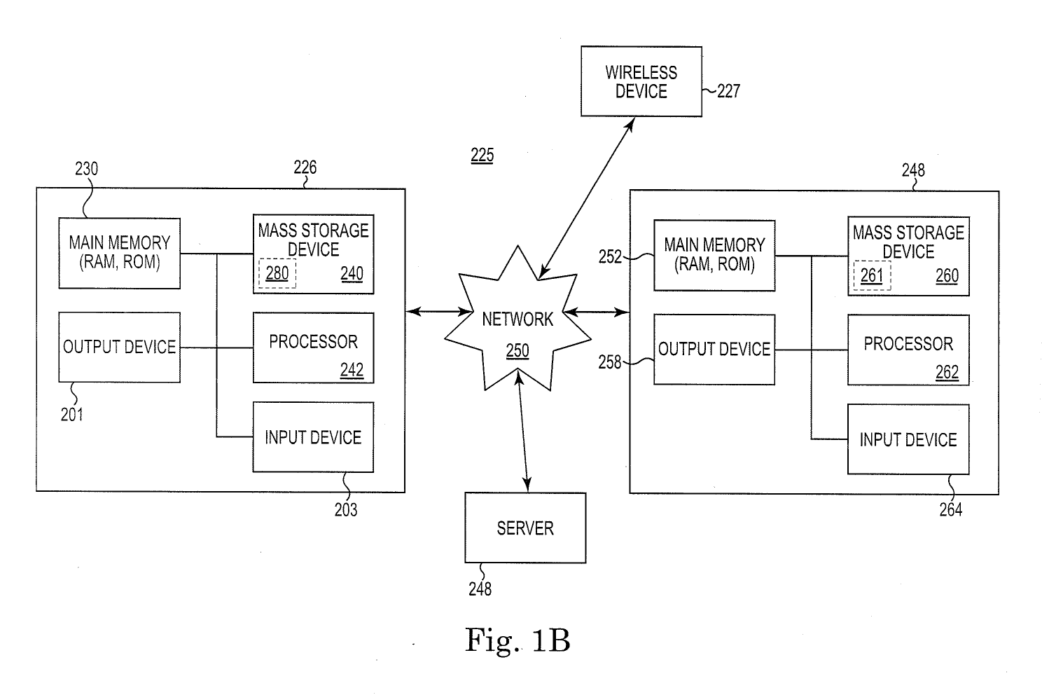

FIG. 1a depicts an interrelationship model 100 between parties-at-interest using a social engagement engine 101 in accordance with one embodiment of the present disclosure. As is shown therein, the social engagement engine 101 has reciprocal interactions with one or more companies or other entities 105 that provide healthcare insurance to their own employees, a plurality of health care consumers 110, a social engagement engine system manager 115, one or more corporate sponsors or advertisers 120, one or more healthcare providers 130, which may include, for example, hospitals, clinics, doctors, physicians, specialty practices, etc., and one or more insurance companies or managed care providers 140. With regard to the health care consumers 110, such healthcare consumers may form one or more teams 111 and 112, comprised of members 111a, 111b, and 111c, and members 112a and 112b. Such healthcare consumers, or teams of health care consumers 110 may use the social engagement engine to form teams, to track health conditions, to engage in challenges, to encourage other persons who were not yet users of the social engagement engine to join their team, or another team, and to generally engage in a social network wherein a goal is to improve the overall health conditions of its members. As shown, the plurality of healthcare consumers may be related through an employment relationship with one or more companies or other business entities 105, wherein such business entities 105 have a relationship with the social engagement engine 101. The companies 105 may use the services of the social engagement engine to set up, and/or run company specific versions of the social engagement engine 101 platform, wherein the employees may be members of one or more teams particularly related to such company. In this manner, employees from a single company or two or more companies can compete against one another, using the team format, to engage in challenges and compete against one another to improve their overall health conditions. In this manner, the social engagement engine can be employed to encourage competition and thus increase the overall health benefits achieved between the employees, thereby potentially lowering the healthcare costs that the participants' companies spend on health benefits. The social engagement engine system manager 115 may function to manage the operations of the social engagement engine 101, including all operational, networking, and technical aspects of the social engagement engine 101 and to interact and engage with the other parties-at-interest shown in FIG. 1a. Thus, the social engagement engine system manager 115 may be a business entity that provides the software and/or other data/network services that allow the social engagement engine 101 to perform the functions described herein. In some embodiments, the social engagement engine system manager 115 may be the company or business entity 105, such that the company or business entity 105 has direct control over all aspects of the social engagement engine features that its employees may use any connection therewith.

Also shown in FIG. 1a is a plurality of corporate sponsors 120, including corporate sponsors 121 and 122. Such corporate sponsors 120 may use the social engagement engine to advertise their products and services, which may be health-related products and services. In some embodiments, corporate sponsors may simply provide a donation for the benefit of the social engagement engine, in order to promote improved health conditions of the social engagement engine users. Corporate sponsors 120 may advertise their products and services on the social engagement engine in a variety of matters, including, but not limited to, posting their logo on the social engagement engine for brand recognition, providing monetary or other awards to the winner or winners of challenges, or providing products and services to the winner or winners of challenges, among other things. Also shown in FIG. 1a are a plurality of health service providers 130, which may include one or more hospitals, clinics, or other health providing organizations 131, and one or more direct service providers 132 including doctors, physicians, and other specialty practitioners, among others. Such health service providers 130 may engage in a relationship with the social engagement engine to directly interact with health care consumers to provide advice or other information to the health care consumers in their pursuit of overall improved health conditions using the social engagement engine 101. Such health service providers 130 may also have a business relationship with the social engagement engine through the social engagement engine system manager 115, business entity 105, or an insurance plan administrator 140 in order to provide healthcare services to users of the social engagement engine. The insurance plan administrator, in turn, may interact with the social engagement engine by providing incentives to businesses 105 and health care consumers 110 for using the social engagement engine 101, including, for example, reduced health insurance premiums, reduced co-pays, or other incentives to use the social engagement engine 105 and thereby improve their (or their employees) overall health condition, which may reduce health care costs to the insurer.

Embodiments of the presently disclosed social engagement engine may be implemented through one or more computing devices connected with one another through an electronic network. That is, health care consumers can access the social engagement engine electronically in variety of manners. Moreover, the social engagement engine itself may be implemented electronically on one or more computer systems, as discussed below.

As shown particularly in FIG. 1b, a computing device used with the present disclosure, may be part of a larger network system 225 of devices. System 225 may include one or more computing devices 226 connected with a network 250, such as the Internet. Computing device 226 can interact with a server 246 in order to input and receive information, for example but not limited to, health tracking information from user devices in connection with use of the social engagement engine, as will be described in greater detail below. The server 246 may be configured to send or receive data from user devices as user engage and interact with the social engagement engine.

System 225 may also include the ability to access one or more web site servers 248 in order to obtain content from the Internet for use with the social media-based systems and methods described herein. While only one computing device is shown for illustrative purposes, system 225 may include a plurality of computing devices 226 and may be scalable to add or remove computing devices to or from a network.

Computing device 226 illustrates components of an embodiment of a suitable computing device for use with the present disclosure. Computing device 226 may include a main memory 230, one or more mass storage devices 240, a processor 242, one or more input devices 244, and one or more output devices 236. Main memory 230 may include random access memory (RAM), read-only memory (ROM), or similar types of memory. One or more programs or applications 280, such as a web browser, and/or other applications may be stored in one or more data storage devices 240. Programs or applications 280 may be loaded in part or in whole into main memory 230 or processor 242 during execution by processor 242. Mass storage device 240 may include, but is not limited to, a hard disk drive, floppy disk drive, CD-ROM drive, smart drive, flash drive, or other types of non-volatile data storage, a plurality of storage devices, or any combination of storage devices. Processor 242 may execute applications or programs to run systems or methods of the present disclosure, or portions thereof, stored as executable programs or program code in memory 230 or mass storage device 240, or received from the Internet or other network 250, for example, a network connecting the computing devices to the system of the social media platform. Input interface 203 may include any device for entering information into computing device 226, such as but not limited to, a microphone, digital camera, video recorder or camcorder, keys, keyboard, mouse, cursor-control device, touch-tone telephone or touch-screen, a plurality of input devices, or any combination of input devices. Output device 201 may include any type of device for presenting information to a user, including but not limited to, a computer monitor or flat-screen display, a printer, and speakers or any device for providing information in audio form, such as a telephone, a plurality of output devices, or any combination of output devices.

Applications 280, such as a web browser, may be used to access the social engagement engine, for example, by connecting to the host server of the social engagement engine, e.g. the system manager 115 shown in FIG. 1a. Any commercial or freeware web browser or other application capable of retrieving content from a network and displaying pages or screens may be used. In some embodiments, a customized application 280 may be used to access, display, and update information.

A server 246, for example, located at the system manager location, or other server location such as may be employed in a “cloud” computing network, may also be connected to the network 250. Server 246 may include a main memory 252, one or more mass storage devices 260, a processor 262, one or more input devices 264, and one or more output devices 256. Main memory 252 may include random access memory (RAM), read-only memory (ROM), or similar types of memory. One or more programs or applications 281, such as a web browser and/or other applications, may be stored in one or more mass storage devices 260. Programs or applications 281 may be loaded in part or in whole into main memory 252 or processor 262 during execution by processor 262. Mass storage device 260 may include, but is not limited to, a hard disk drive, floppy disk drive, CD-ROM drive, smart drive, flash drive or other types of non volatile data storage, a plurality of storage devices, or any combination of storage devices. Processor 262 may execute applications or programs to run systems or methods of the present disclosure, or portions thereof, stored as executable programs or program code in memory 252 or mass storage device 260, or received from the Internet or other network 250. Input device 264 may include any device for entering information into server 246, such as but not limited to, a microphone, digital camera, video recorder or camcorder, keys, keyboard, mouse, cursor-control device, touch-tone telephone or touch-screen, a plurality of input devices, or any combination of input devices. Output device 256 may include any type of device for presenting information to a user, including but not limited to, a computer monitor or flat-screen display, a printer, or speakers or any device for providing information in audio form, such as a telephone, a plurality of output devices, or any combination of output devices.

Server 246 may store a database structure in mass storage device 260, for example, for storing customer feedback information, and other data. Any type of data structure can be used, such as a relational database or an object-oriented database. In general, server 246 may be used to monitor and control all aspects of operation of the social engagement engine, and may be a component of the social engagement engine system manager 115.

Processors 242, 262 may, alone or in combination, execute one or more applications 280, 281 in order to provide some or all of the functions, or portions thereof, of the social engagement engine system and method described herein.

Furthermore, users of the social engagement engine may be able to access some, any, or all of the features of the social engagement engine using, in additional to the personal computing systems described above, mobile devices 227, including, but not limited to, smartphones, PDAs, handsets, cell phones, tablet computers, and other known devices with mobile internet access. The social engagement engine may present the same webpage or other interface to a mobile device 227 user as with a traditional personal computer user. Alternatively, the social engagement engine may present a page view that is adapted to the optimized viewing format of the particular mobile device using, for example, a “.mobi” version of the social engagement engine webpage or other interface.

Particular modules and other aspects of a social engagement in accordance with the present disclosure will now be described. Initially, when the healthcare consumer begins interaction with the social engagement engine, the first webpage or other interface that may appear to the healthcare consumer or other user of the social engagement engine may be a standard “home” page. In order to gain access to this home page, the user may be required to provide identification information to access, or to “log-in,” to the social engagement engine. Identification information may include a username, password, or other identifying information, such that the social engagement engine recognizes a particular user thereof, and thereafter displays a particular account, via a webpage or other interface, of the social engagement engine that the user has previously set-up. Where the user is new to the system, the user may first be required to enter such identification information to set up an account on the social engagement engine.

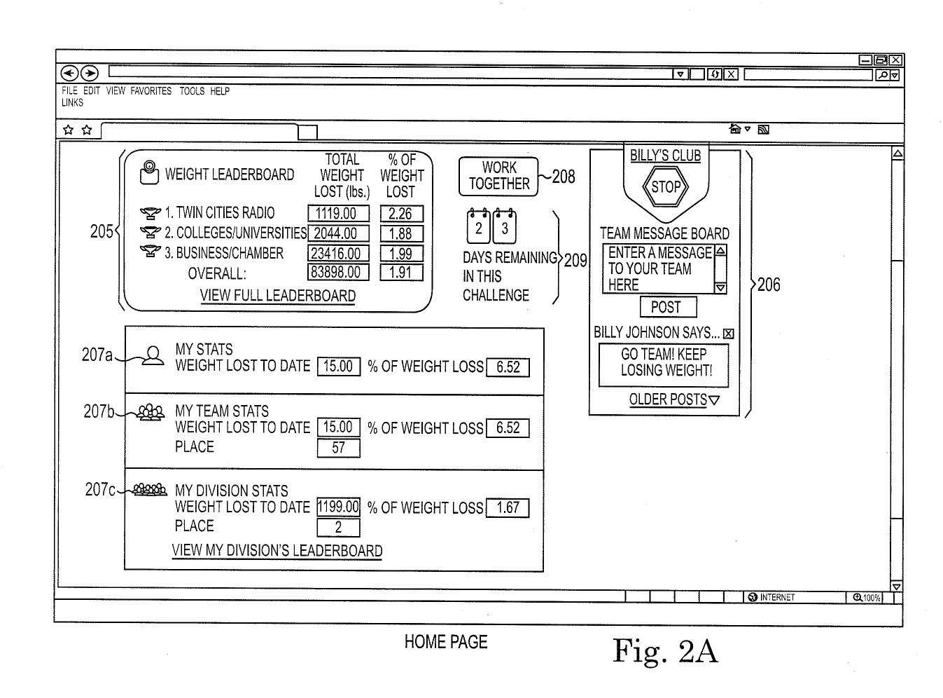

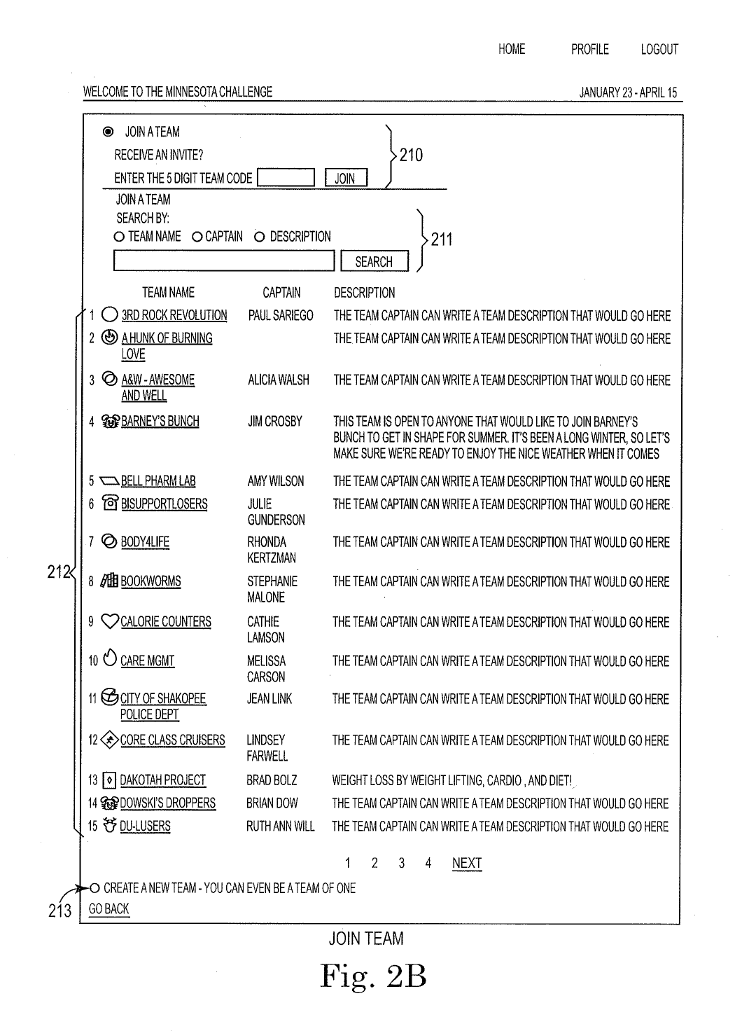

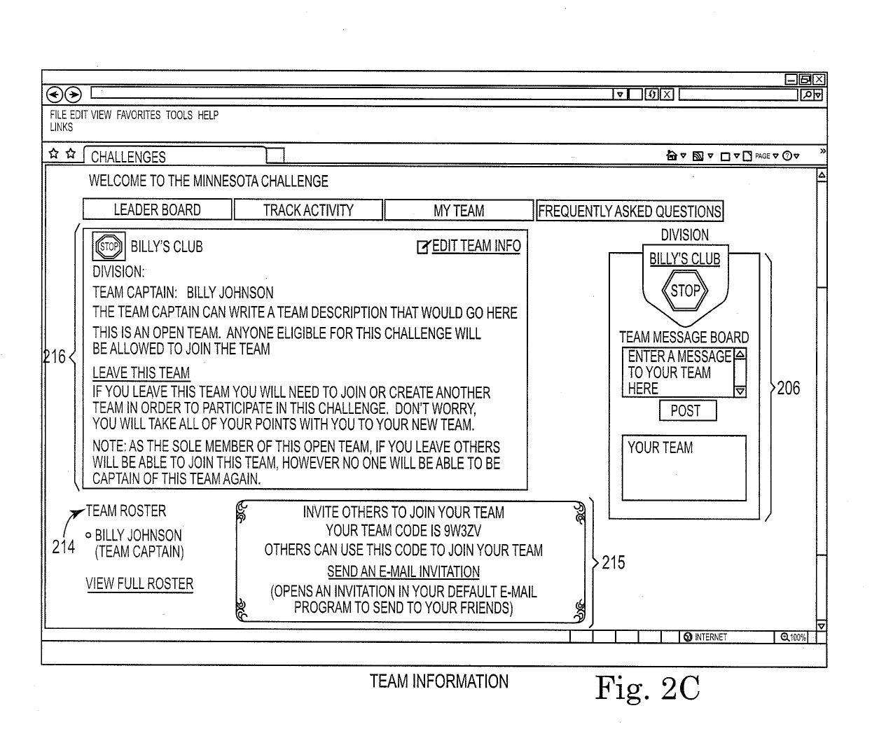

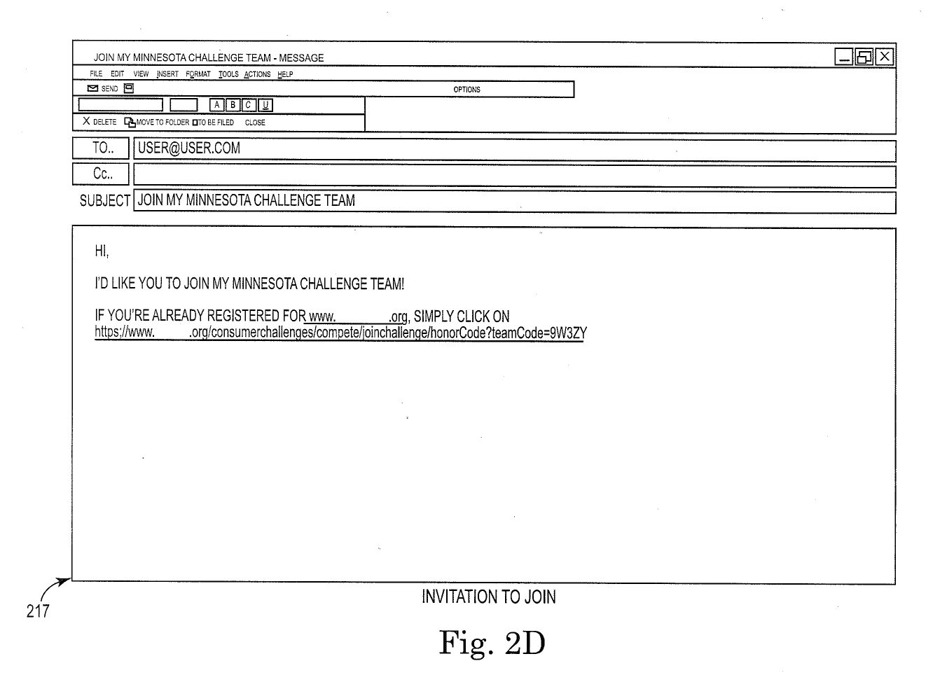

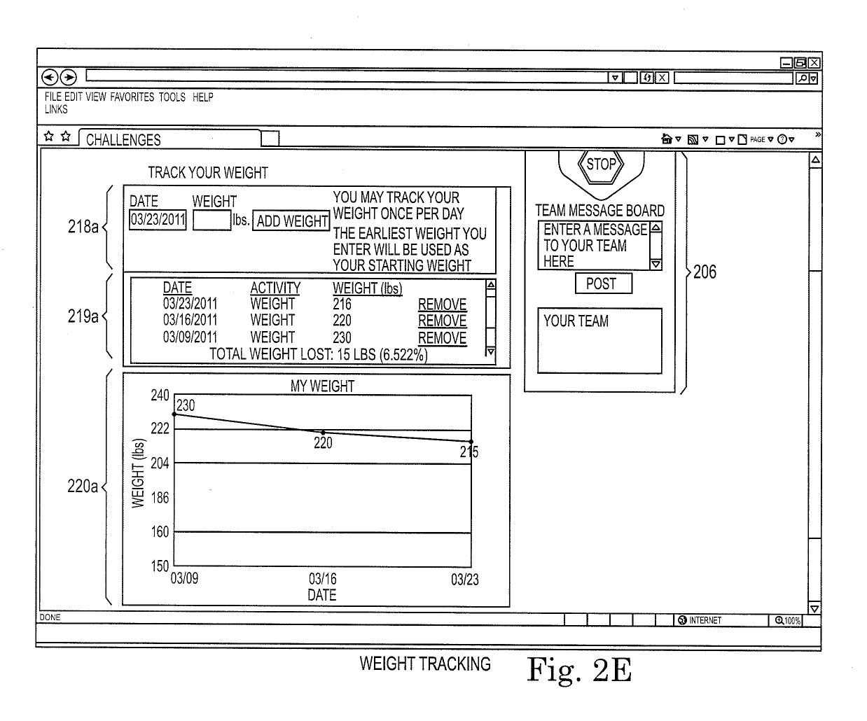

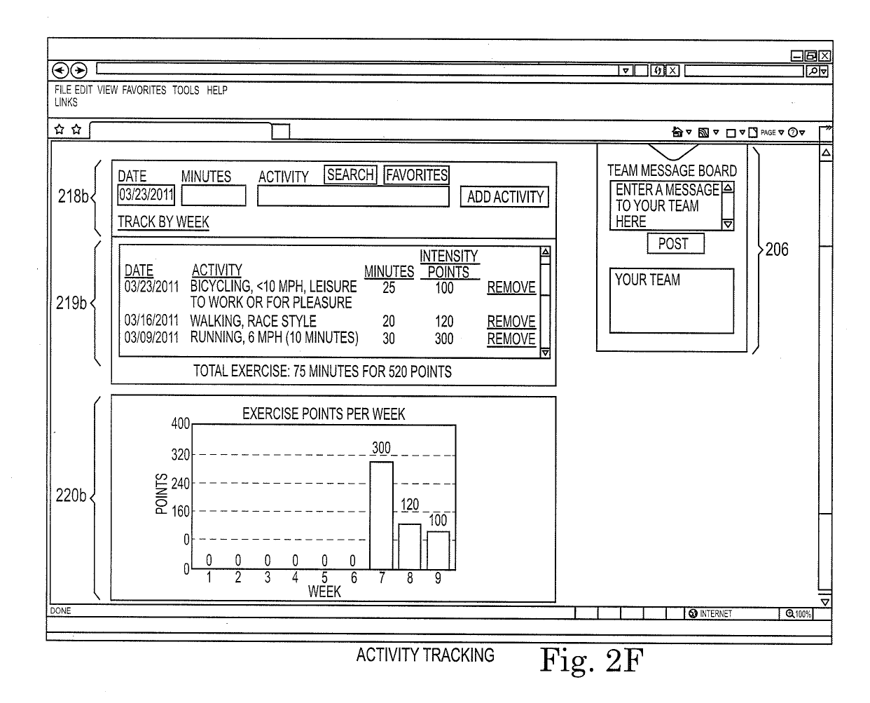

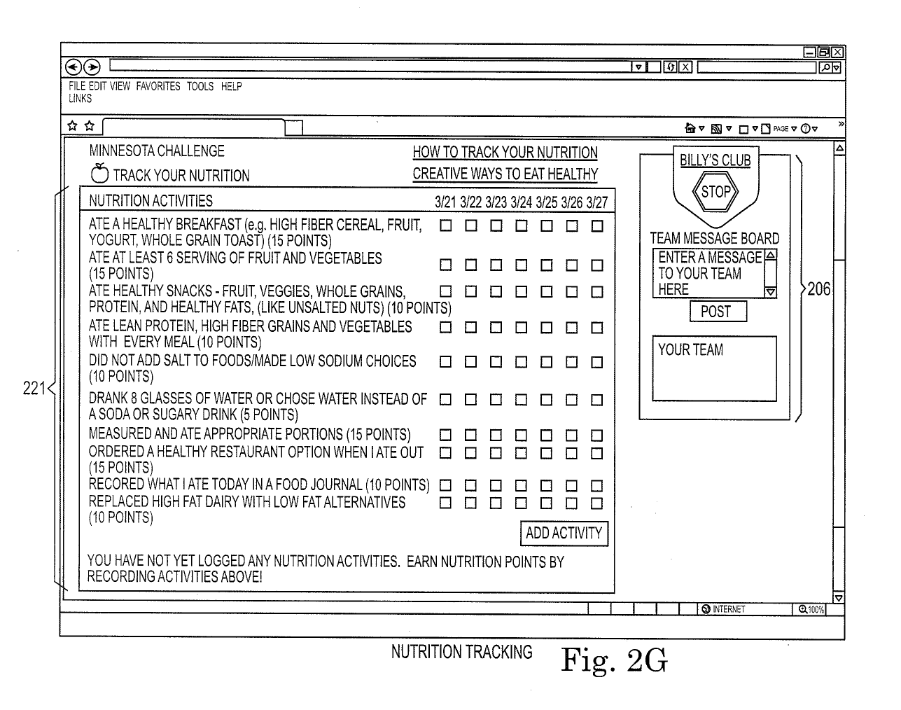

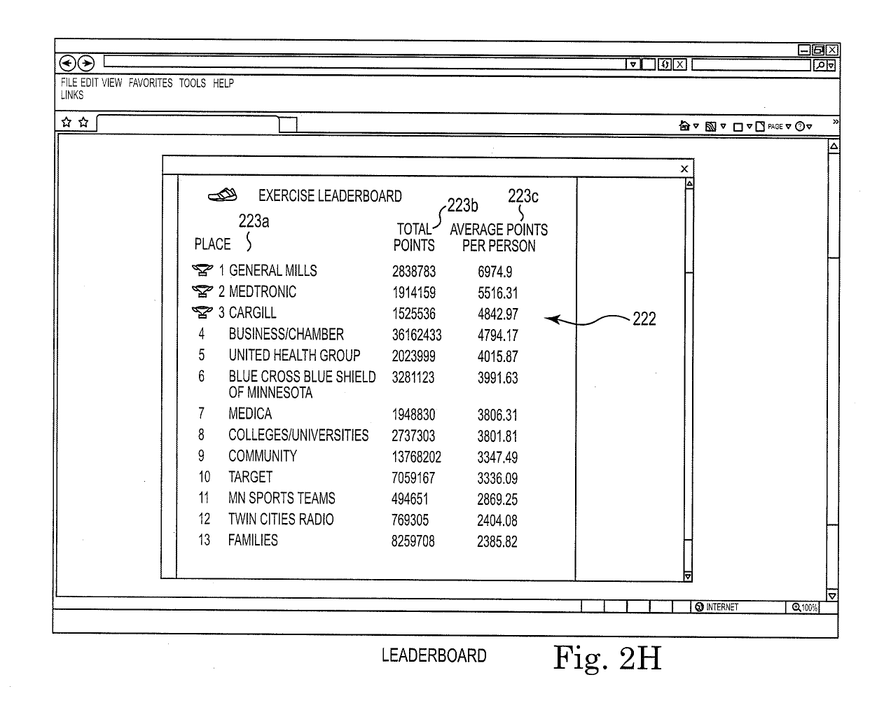

FIG. 2a shows an example homepage or interface that may be provided to a user by the social engagement engine upon verification of the user's login credentials. The homepage may include, for example, one more leader boards 205, wherein the user may be able to see a snapshot of the current status of one or more challenges for which the user is engaged. The status or snapshot may include, but is not limited to, a current listing of the ranked order of teams participating in the challenge, their scores or progress in the challenge, and/or an indication of time remaining in the challenge, etc. It may also include a snapshot of tracked health conditions, for example, weight loss is shown in the example of FIG. 2a at 207a. However, it is recognized that snapshots of any other health conditions for the user may alternatively or additionally be shown, such as, but not limited to, exercise, habit cessation, nutrition, etc. The homepage may also include information regarding team-related health condition data 207b (team weight loss is shown in the example of FIG. 2a). Again, it is recognized that information regarding any other health conditions for the team may alternatively or additionally be shown, such as, but not limited to, exercise, habit cessation, nutrition, etc. Furthermore, if the team to which the user belongs as part of a division, statistics related to that division 207c may be shown on the homepage (weight loss statistics are shown with regard to the particular division which the user is associated). Again, it is recognized that information regarding any other health conditions for the division may alternatively or additionally be shown, such as, but not limited to, exercise, habit cessation, nutrition, etc. In some embodiments, the homepage may include any suitable additional information, including but not limited to, days remaining in a challenge 209, encouraging messages 208, and a message board 206, wherein other members of the user's team, or the user, may post messages to one or more other users, etc.

As previously discussed, one particular module of the social engagement engine may include a team formation module wherein users of the social engagement engine many join together to form a team to, for example, engage in challenges, compete against other teams, and/or track information regarding various health-related aspects. A team may be formed at the initiation of one or more persons, who may or may not already be users of the social engagement engine. Such initiating person or persons may designate themselves as a leader of the team, or they may invite someone else to be the leader. The team leader may be in charge of designating or selecting the various characteristics pertaining to the team, which may include, for example, team size, team status, challenges in which to participate, membership requirements, and other aspects particular of the team to be formed.

In order to form a team, the team formation module may require certain information to be entered. Such information may be used to create a team roster, which may provide a listing of the members of the team, in addition to information related to such team members. The team leader may select or designate what information is required from each team member to form the team. Such information may include, for example, member contact information, member affiliations (for example, employment with a particular company or organization), member interests, and/or other information. The team leader may also designate which information is publicly available and which may be retained as private. Alternatively or additionally, the social engagement engine may apply similar public/private rules to the user information. Each member that joins the team, and each user of the social engagement engine in general, may be assigned a particular user identification, and in some embodiments, an associated password, in order to access the social engagement engine, and in order to access team specific information on the social engagement engine.

Teams formed using the formation module of the social engagement engine may be designated by the leader, or by another person, as an open or closed team. In an open team, any user of the social engagement engine can join the team, and participate in challenges and the various other aspects of team membership. In contrast, teams may be designated as closed teams, wherein the team membership is limited to particular users of the social engagement engine. Such closed teams may be interest-specific or association-specific teams, including for example, teams related to a particular employer, teams related to a particular organization, teams whose members have a collective interest, teams related to a particular affiliation, or other specific designation. In one embodiment, in the case of closed teams, a user of the social engagement engine or other person may only join such team when an invitation is sent to such user or person. The invitation may include team-access information, which may include an access code, electronic link, or other means by which the person is permitted to join the team. In some embodiments, a separate invitation module may be provided for this specific purpose.

Teams may be formed of any size, including as few as one person, up to an unlimited number of persons. The team leader may designate the maximum size, or specific size, of the team upon formation. In some embodiments, the team size me be dynamic, wherein users of the social engagement engine are allowed to leave or to join a team after it has been formed. Further, the designation of a maximum or specific team size may be changed by the leader, or other person, after the team has been formed, e.g., at any time.

Teams may be formed in connection with any designated association or affiliation of users of the social engagement engine. For example, a team can be formed around a particular company that engages the services of the social engagement engine, or around a particular organization whose members are interested in improving their overall health. In other embodiments, teams may be formed around a particular geographic region, for example, by city, by region, by state, by nation, or by any other geographic scope. In still other embodiments, teams may be formed around a particular interest that the team members share, for example, but not limited to, sports interests, social interests, topical interests, etc.

In some embodiments, a team may be formed as “multi-tiered,” wherein there are one or more sub-teams within the team. A sub-team can include any subset of the members of the team. In various embodiments, a team member may belong to none, one, or a plurality of sub-teams within the team. Sub-teams may also have their own sub-teams, i.e., sub-sub-teams, and so forth in two, three, four, or more tiers, for example. In challenges, teams having sub-teams may compete against other teams that do or do not have sub-teams. Sub-teams within a team may also compete internally against each other, and in some embodiments, sub-teams from one team may compete against sub-teams from another team. In such various embodiments, challenges between teams may be based on one or more goals, and the competition may be based on an aggregate team score (i.e., the sum total of all, or some sub-portion of, sub-team scores within the team). Alternatively, the competition may be based on a comparison of individual sub-team scores between teams, or a combination of overall team scores and sub-team scores. In this manner, competition between teams in challenges can be tailored to the specific needs and desires for each participating team.

In some embodiments, teams may be formed as multi-tiered wherein there are multiple teams or multiple designations within a particular team. For example, some members of the team may be interested in tracking one particular health condition, and competing on that basis, whereas other members of the team may be interested in tracking another particular health condition, or two or more health conditions, and may be interested in competing on that basis. Therefore, in this type of “team within a team” structure may be useful for large teams, for example company affiliated teams, wherein the members of the overall team have divergent interests in improving their health conditions.

In some embodiments, a user who is a member of the team may be allowed to leave a team, join another team, or switch team memberships. This functionality may be associated with the previously mentioned dynamic characteristic of some teams. When a user leaves a team to join another team, or when a user joins an additional team, all of the user's information relating to the user's account on the social engagement engine will transfer to such new or additional team, thereby allowing the user to switch teams without re-entering all of the information that the user has to enter when joining the user's initial team. This functionality allows for ease of portability between teams, so that the user can engage in only the activities and challenges desired to improve their health condition, thereby increasing the likelihood that the user will remain engaged with the social network formed around the social engagement engine.

In some embodiments, teams may be hosted by a particular company or organization, wherein such company or organization or a designated person(s) therewith may assume the responsibility of team leader, and designates the characteristics and membership attributes of that particular team (which otherwise, as discussed above, would be performed by one or more individual team leaders). This “hosted” team configuration, or “private” team configuration, may be useful where a company desires to use the social engagement engine to improve the overall health condition of its employees, thereby lowering the company's healthcare costs. In these examples, the team within team configuration, as discussed above, may be particularly useful so as to allow the employees of a particular company to select what health conditions they wish to improve (and compete against others in connection therewith), while remaining part of the overall company team, as a basis on which to compete. In particular, the hosted team configuration may be used in connection with an employee health plan, wherein team members receive a discount on their health insurance premiums or other reward(s) for participating as a member of the team or in certain challenges.

In one embodiment, a “private” team configuration may include an interrelationship between one or more private companies or organizations and the social engagement engine. In the private configuration, the company (or companies), on its own or in connection with the social engagement engine manager, may configure one or more teams and challenges based on criteria that the company desires, which may be criteria specific to that company. For example, teams may be formed within the company, based on, for example, divisions within the company, floors within the company office building, departments within the company, or any other characteristic related to the company around which a team may be formed.

In contrast to the private team configuration, team formation using the social engagement engine may be made “public.” That is, a person need not be an employee of or otherwise associated with a particular company in order to join a team and participate in challenges. Such public teams may still be formed around a particular area of interest, and may or may not be limited in membership (i.e., upon invitation only), but the members need not be affiliated with a particular company or organization.

FIG. 2b shows an example team joining webpage or other interface of the social engagement engine, wherein a user may select from a variety of teams to join. As shown, the user can enter whether or not an invitation was received 210 (e.g., whether they have an invitation code, etc.), or may search for a particular team 211 by team name, team captain (leader), or by description, among other things. Alternatively, a listing of available teams 212 may be shown and browsed. At that point, the user can click on a particular team shown on the user's webpage or other interface, and thereby initiate the team joining process. Alternatively, the user has the option to create their own team, by selecting an appropriate option 213 of the module.

Once a team has been formed, or once a user joins a team, a team information webpage or other interface may be presented to the user by the social engagement engine, as shown by way of example in FIG. 2c. A team information webpage or other interface may include a team code 215, which may allow the user to invite other users or other persons to join the team, a team roster 214, which may include information about team membership, and/or personal information regarding team members, and/or an overall description of the team 216, including characteristics, affiliations, challenges, designations, or other pertinent information regarding the team. Alternatively, the team code may only be provided to a team leader or other person(s) designated by the team leader, and invitation of others may be limited to the discretion of such person(s). The user may access the team information interface at any time, and in some embodiments, may access this information or some of this information prior to joining the team.

When a team member selects the aforementioned option to invite another user or another person to join the team, the invitation module of the social engagement engine may create a message in the user's e-mail application, directed to the person(s) sought to be joined, inviting that person or persons to join the team, and supplying a person with the access information to join the team. In some embodiments, the team member may have to enter some or all of this information manually. As shown by way of example in FIG. 2d, an e-mail message 217 is provided in an e-mail exchange application and addressed to the person sought to be joined, inviting such person to join as a member of the team, and providing a webpage or other interface address to the social engagement engine, along with a web link to allow access to the team.

A user of the social engagement engine, or team of users, may select one or more health-related goals as a basis for which to track information regarding a health condition, or as a basis for which to engage in challenges with other users or other teams. Health-related goals may include any conditions or aspects related to personal health, such as but not limited to weight loss, exercise or activity, nutrition, prevention of adverse health conditions and/or disease, and cessation of harmful behaviors, or any suitable combination of conditions or aspects related to personal health. In one example, a weight-loss goal may involve the loss of a particular amount of weight or a particular percentage of weight (as a percentage of user's overall weight). In another example, an exercise or activity goal may include a minimum number of minutes per day engaged in an activity or a minimum number of days per week wherein an activity is performed. In another example, a nutrition goal may include eating a particular type of food (or not eating a particular type of food) in a given timeframe. In a further example, a cessation goal may include quitting smoking, quitting drinking alcohol, etc., in a given timeframe. Of course, goals may include multiple individual goals, or a combination of goals.

In one embodiment, within any team, the goals of its members may be the same, or they may be different. Teams may compete against other teams on the basis of the same goal or on the basis of different goals. Where different goals are desired, a multi-tiered team structure may allow the teams to compete against one another wherein each tier or sub-team competes in the challenge on the basis of the same or different goals. In another embodiment, within any team, regardless of tier structure, one or more individuals may compete in the challenge on the basis of the same or different goals. In embodiments where teams, sub-teams, tiers, or individuals compete on the basis of different goals, a scoring algorithm or correlation factor(s) may be used to equate the scores earned by such teams, sub-teams, tiers, and/or individuals so that a relative comparison can be made amongst the respective teams, sub-teams, tiers, and/or individuals to determine a ranking. For example, one member of a team may compete on the basis on one goal, for example, weight, whereas another member of the team may compete on the basis of another goal, for example, habit cessation. Scores between such members may be correlated using an algorithm or set of factors. For example, a given number of pounds lost may be the equivalent to a habit cessation for a given period of time. Other factors can similarly be created for other goals. Furthermore, any team, or team within a team, may compete on the basis of multiple goals, or combined goals. In one example, a team may compete with another team on the single basis of weight loss amount, wherein the team that loses highest number of pounds wins. In another example, a team may compete on the basis of both weight loss and activities performed, wherein the winner is the team that has the highest score, the score being determined by an algorithmic combination of both weight loss and activities performed. In a particular embodiment, in general, an entity or team that uses the services of the social engagement engine can compete against another such entity or team that uses the services social engagement engine, wherein individual sub-teams within an entity or team can compete against each other on the basis of similar or dissimilar goals and the overall entities or teams can compete against each other on the basis of similar or dissimilar goals, which may be the same or different goals as goals of the individual sub-teams within each team. In more general terms, any team, sub-team, tier within a team, or individual within a team may compete in a challenge on the basis of any goal. Using the correlation algorithm or factors, any number of scores (individual or combined) resulting from the participation of any team, sub-teams, tier, or individual in the challenge for any goal(s) can be ranked against any number of scores (individual or combined) resulting from the participation of any other team, sub-team, tier, or individual in the challenge for any goal(s).

As previously discussed, the social engagement engine of the present disclosure may include one or more challenge modules. A challenge module may allow for the configuration of a competition between two or more teams on the basis of one or more goals. A user of the social engagement engine may employ the challenge module to designate one or more challenge bases (e.g., goals) and one or more challenge participants. Challenge participants may be either teams or individuals. A user employing the challenge module may thereby designate the characteristics of the challenge, setting determinants for participation, for scoring, for length of time, for winning, for awards, and/or for any other aspects of the challenge. The user may employ the challenge module to invite other individuals or teams to engage in the challenge, and in connection therewith inform such other users or teams of the criteria for the challenge. A particular company or other business entity may employ the challenge module to create a challenge for its employees or members to participate in against a competing company or entity, using a “private” configuration of the social engagement engine. In other embodiments, a challenge and all its attendant parameters may be configured by the social engagement manager.

In one embodiment, generally any person or any entity can initiate a challenge by selecting the parameters for the challenge using the challenge module. This includes team captains or any individual within a team, any organization (e.g., a private company) or any member within such organization, the social engagement engine manager, or even third parties, such as public entities, e.g., a public health organization. In other embodiments, challenge initiation and design may be limited to particular persons or entities.

In one embodiment, the challenge module may allow for competitions within an organization. In a private team configuration, for example, as discussed above, one or more teams within a company or other organization may compete against one another in challenges. For example, one floor within a company building may compete in challenges against another floor. Alternatively, one department or division within a company or organization may compete against another department or division within the company. Such challenges that occur between teams within a company or organization may be designed, executed, or otherwise implemented by the company or organization itself, or it may be implemented by the manager of the social engagement engine in cooperation with the company or organization.

In connection with the challenge module, the presently described social engagement engine may include a tracking module. A tracking module may be configured generally so as to accept qualitative or quantitative data regarding a particular health condition to be tracked. This data may include, for example, weight, which may be measured in pounds or other suitable scale, wherein the tracked condition is weight. The data may also include exercise or activity duration, which may be measured in minutes or other suitable scale, wherein the tracked condition is exercise or activity engagement. The data may further include food consumption information, for example, calories, fat content, carbohydrates, fiber, or any other aspect of food consumption information wherein the tracked condition is nutrition. Additionally, the data may include habit cessation information, for example, a period of time for which a particular habit or habits have not been engaged in, wherein the tracked condition is cessation. Other data may be associated with these or different tracked conditions in accordance with the present disclosure.

A user may track one more health conditions using the tracking module in a manual or automatic manner. Manual tracking, in one embodiment, may involve the user entering data into the tracking module through the webpage or other interface provided by the social engagement engine. In one particular example of manual tracking relating particularly to an example weight loss challenge, as shown in FIG. 2e, a user may manually select a date, and then manually enter a weight in pounds in a data entry area 218a, wherein such date and weight may be added to the tracking module and stored at a data storage medium provided in connection with the social engagement engine. In other embodiments, data entered may include none, some, or all of the above data, and/or other data not shown in the example. The weight tracking information may be displayed to the user thereafter on a weight tracking listing 219a, which may include a chart 220a or other visual indication of how the user's weight has changed over time.

In another example relating particularly to an example activity challenge, as shown in FIG. 2f, a user may manually select a date, and then manually enter an activity and duration in a data entry area 218b, wherein such date, activity, and duration information is added to the tracking module of the social engagement engine. In other embodiments, data entered may include none, some, or all of the above data, and/or other data not shown in the example. The activity tracking information may be displayed to the user thereafter on an activity tracking listing 219b, which may include a chart 220b or other visual indication of the user's activities engaged in over a period of time.

In yet a further example of manual tracking relating particularly to an example nutrition challenge, as shown in FIG. 2g, a user may enter food information eaten on a particular day by selecting from among a variety of possible food options in a table 221. In other embodiments, data entered may include none, some, or all of the above data, and/or other data not shown in the example. As before, such information is stored by the tracking module of the social engagement engine, and may be visible to the user thereafter on a nutrition tracking page. Other options for manual data entry include data fields, drop-down menus, radio icons, checkboxes, and other known data entry formats. Of course, it will be appreciated that manual entry may be used to track any information for any health related condition or aspect thereof, etc.

In some embodiments, the tracking module may receive data regarding a tracked condition automatically from one or more condition tracking devices. These devices may include, for example, pedometers, heart rate monitors, blood pressure monitors, and other electronic devices that can determine and store health condition information. Such data may then be uploaded to the social engagement engine via the tracking module electronically over a network, such as by connecting the device to a computer that has network access, or by directly connecting the device to a network such that the information may be downloaded to the social engagement engine.

Throughout the course of a challenge, the social engagement engine may be configured to provide the user with coaching messages based on the tracked data entered. Such coaching messages may include information regarding how to better improve scores (e.g., how to best achieve the stated goals), how to resolve problems experienced during the challenge regarding the tracked health condition, or any other aspect of the challenge, or simply encouraging information that congratulates the user for a good job so far and/or encourages the user to keep up the good work towards achieving the goal. In some embodiments, such as shown in and described in conjunction with FIG. 2a, the users themselves can send messages to one another regarding their participation in a challenge, regarding the status of a challenge, to social network with one another, to update their status, or to provide any other information. In still other embodiments, third-party coaches may provide messages as described above.

In some embodiments, the social engagement engine of the present disclosure may be provided with a scoring module that functions in cooperation with the challenge module and the tracking module. In these embodiments, the scoring module may obtain information from the challenge module regarding the entered parameters of the challenge, which may include, as discussed above, challenge criteria, goals, timeframe, and/or other challenge information.

From this information, and from information obtained from the tracking module, the scoring module may aggregate tracked data from all the participants within the challenge. Data may be aggregated within the social engagement engine by a separate aggregation module configured to receiving information from the tracking module, and to store it in a common format in one or more data storage media provided in connection with the social engagement engine. The aggregated data may be compared against the challenge criteria, as defined in the parameters set prior to commencement of the challenge. This comparison may allow the use of one or more scoring algorithms, as will be discussed in greater detail below, to provide a current score for a user or for a team engaged in the challenge.

Scoring may be calculated in a variety of manners. In one algorithm, numerical data from one user or from one team may be ranked against numerical data of the same type (for example, weight) from another user or from another team, in order to determine a current score or a current ranking. In another algorithm, a combination of different types of numerical data from one user or from one team may be ranked against a similar combination of numerical data from another user or from another team in order to determine a current score or a current ranking. In still a further embodiment, qualitative tracked data (for example, food consumption tracking) may be assigned a numerical score by the scoring module, and then such numerical score from one user or from one team may be compared against a like converted numerical score from another user or from another team in order to determine a current score or a current ranking. Of course, a combination between numerical data and converted scoring, in order to determine an overall score, it is possible. Again, the criteria and scoring for each challenge may be determined by the challenge parameters set by the challenge leader or challenge initiator at the beginning of the challenge.

Scoring may be determined on either an individual or a team basis, depending on how the challenge is designed. In some embodiments, it may be determined on both an individual and a team basis. Thus, in these embodiments, there may be several subsets of scores pertaining to different individuals or different sub-teams in the challenge, and overall scoring may be determined on a combined basis thereof. Of course, any combination or permutation of scoring possibilities related to individuals, teams, or sub-teams are possible in connection with any given challenge.

Scoring may also be determined across one or more goals. For example, a team that scores weight loss may compete against a team that score habit cessation by designing an appropriate correlation between the respective scores. For example, a given number of pounds of weight loss (for example, 5 pounds) may be equivalent to habit cessation for a given period of time (for example, two weeks). Other correlations between other goals may thus be determined. In this manner, teams can compete against each other even where they are tracking different goals. In a further embodiment, members of the same team may compete on the basis of different tracked goals. For example, one member of a team may track weight loss, while another member of the team may track habit cessation. Scores may be compared, aggregated, correlated, etc. in the same manner as described above. In this manner, people can join a team of common interest, or within an organization, etc., while tailoring their goals to their own particular health needs.

A challenge module in accordance with the present disclosure may require users or teams engaged in such challenge to enter data, or to provide other updates, at regular or irregular intervals. Such intervals may be determined at the outset of the challenge by the challenge leader or initiator. At such intervals, the challenge module may provide a reminder message, which may be in electronic form, to users or teams to remind them to enter or update challenge information, including tracked conditions. Furthermore, at such intervals, the challenge module (alone or in combination with the scoring module) may provide users or teams with updated information regarding the challenge, as will be discussed in greater detail below. Of course, data need not be entered at particular intervals, but may be entered at any time.

In one embodiment, challenge information or status may be provided to users or teams. While such information may be provided in any suitable format, in one embodiment such information may be provided in a leaderboard format. In these embodiments, a leaderboard may generally include a listing of all users or teams participating in the challenge, along with such users' or teams' challenge score at that point in time, which in some embodiments may be ranked in order. Updates to the leaderboard may be made at intervals, or in real-time. In one embodiment, the listing may be provided so as to place the team with the highest score on top, with lesser scoring teams provided therebelow in sequence, so that the user can visually see how the challenge is progressing. In one example, as shown in FIG. 2h, a leaderboard 222 is shown with a plurality of teams 223a participating in a challenge. Currently in first place is a team from one company, with a team from another company in second place, and so forth. However, non-company affiliated teams or individuals may also be part of the challenge. Additionally shown on the leaderboard are the points earned by members of the team 223b (as would be determined by the scoring module), in addition to average points per member of the team 223c. In other embodiments, the leaderboard may be configured to shown other information or additional information, such as but not limited to rankings that are based on total weight loss, percentage of weight loss, number or percentage of team members who successfully ceased a habit, number or percentage of team members who reached a nutritional goal, number or percentage or team members who engaged in exercise activity at a specified level, etc.

With reference to the above disclosure, FIGS. 2a-2h depict examples of screenshots or interfaces with the social engagement engine of the present disclosure in accordance with some embodiments. As will be appreciated, in other embodiments, these interfaces may be configured in any manner, and may include more or less information, data entry fields, etc.

In further embodiments, the leaderboard may also include progress information regarding the challenge. For example, the leaderboard may graphically show how many days are remaining in a particular challenge, or how much time is left to reach a particular milestone. In some embodiments, near the end of the challenge, the leader board may cease to provide updates regarding scores(e.g., it may be “frozen”) so as to build anticipation near the end of the challenge, such that the users or teams are not quite sure exactly who is winning, which may incentivize the users or teams to try as hard as possible to win, or to achieve the best possible ranking.

Of course, with regard to any particular challenge, a team can decide whether or not they want to participate in the challenge. That is, in some embodiments, there is no mandatory participation requirement with respect to a particular team and a particular challenge. Furthermore, any member of a team can decide individually whether they desire to compete in a particular challenge, and pick and choose the challenges that such person desires to participate in. That is, in some embodiment, there is no mandatory participation requirement with respect to a particular person and a particular challenge. In other embodiment, team or individual participation in a challenge may be made mandatory under the parameters of team or challenge formation, or other parameters.

Once a challenge has been completed, the winning user or team, or a number of top ranking users or team, may be provided with one or more awards. These awards include anything of value to the user of the social engagement engine, and in particular may include, for example, financial awards such as discounts on health insurance premiums or direct monetary incentives, or discounts on products or services, which may include discounts on products or services offered by one or more sponsors of the social engagement engine. In some embodiments, the reward may be as simple as bragging rights for the winning or top ranking team, in the manner of a “social good” award wherein winning itself is the reward. In other embodiments, awards may also relate to charities, wherein a charity receives a donation in connection with a user's participation in a challenge. Such donations may be related to pledges received by the user, milestones achieved by the user, scores achieved by the user, etc. In further embodiments, the award may be tied to other health-related programs in which the user is engaged, for example, other health-related programs that may be operated by the social engagement engine system manager. These programs include, for example, those described in U.S. patent application Ser. No. 12/571,898 filed Oct. 1, 2009, “SYSTEM AND METHOD FOR INCENTIVE-BASED, CONSUMER-OWNED HEALTHCARE SERVICES”; U.S. Provisional Pat. App. No. 61/101889, “SYSTEM AND METHOD FOR CONSUMER-OWNED HEALTHCARE SERVICES”; U.S. Provisional Pat. App. No. 61/101885, “INDIVIDUALIZED HEALTH MANAGEMENT MAP”; and U.S. Provisional Pat. App. No. 61/101888, “SYSTEM AND METHOD FOR HEALTHCARE BASED INCENTIVES”, which were filed on Oct. 1, 2008; all of which are hereby incorporated by reference herein in their entirety. Awards may be provided on an individual basis, a team basis, a sub team basis, or any other combination or division of users in a challenge. Any of the awards described above may be provided in physical or electronic format. For example, a physical award may include a gift certificate to a particular sponsor of the challenge. In the alternative, an electronic or virtual award may include an electronic gift certificate (“e-certificate”) to a particular sponsor of the challenge. Of course, an award may be a combination of a physical and a virtual award, and need not be provided by challenge sponsors or advertisers.

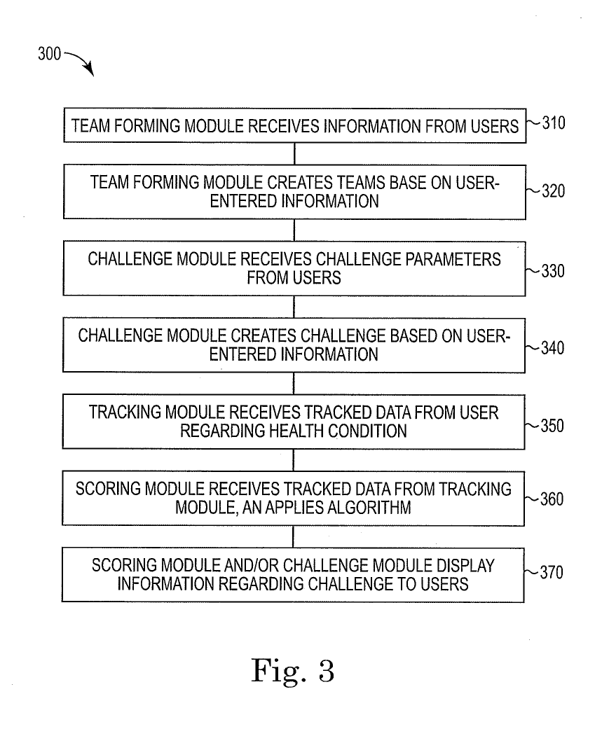

In one embodiment of use, the above-described modules of the social engagement engine may operate in the following manner, as shown in the flowchart 300 of FIG. 3. At block 310, the team forming module of the social engagement engine may receive information from one or more users that may be team leaders, or from one or more organizations, regarding the formation of one or more teams. This information can include team membership characteristics, team size, team membership requirements and attributes, open or closed status, and/or any other team forming information, as was described in greater detail above. Using this information, at block 320, the team forming module may form the one or more teams, and display this information back to the user, for example in the form of a team roster, or other team information page. At block 330, the challenge module of the social engagement engine may receive information from one or more users regarding the initiation of one or more challenges, which may include challenge parameters such as health condition(s) basis, participating users or teams, goals, duration, and other challenge related information, as described in greater detail above. Alternatively, the challenge may be created by the social engagement engine itself or the manager of the social engagement engine. The challenge module thereafter, at block 340, may configure the one or more challenges based on this information, and return the appropriate challenge information to the participants therein, including tracking, reminders, progress information, and scoring updates. At block 350, the tracking module may receive qualitative or quantitative data from one or more users regarding one or more tracked health condition (or goals) involved in a challenge. Such data may include, for example, weight data, food consumption data, or activity data, among other tracked data as discussed above. At block 360, the scoring module may receive the tracked user data from the tracking module and may apply one or more algorithms to generate one or more scores. The scoring algorithms, in one embodiment, may include a simple comparison of numerical data, wherein numerical value are compared with one another in a greater-than/less-than fashion, as determined by the parameters of the challenge. The scoring algorithm, in another embodiment, may include converting qualitative tracked data into a numerical score, wherein certain qualitative values or markers may be converted into a numerical score based on parameters established in the challenge. Of course, any other algorithm, or combination of algorithms, may be used in connection with scoring as described herein. Thereafter, at block 370, the scoring module may display current score information to the user in the form of a leaderboard, a progress update, or other suitable display format. The scoring module, in some embodiments, may cooperate with the challenge module to display the scores to the user in a given user,readable format.

The presently described social engagement engine, including the modules thereof, may be particularly useful to business organizations seeking to reduce insurance costs for its employees because the social networking aspects of use of the engine may serve to encourage many people to participate, thereby encouraging a large number of people to engage in health-conscious activities. It is well appreciated that many people spend a considerable amount of their time engaged in electronic social networking activities. By implementing the presently described modules in a social networking format, wherein users can send messages, send e-mails, send invitations to other users to join, and participate in challenges, the use and popularity of the system can grow and spread in a “viral” manner, wherein other people are interested in joining because their friends and colleagues are already members. In this manner, the social engagement engine allows for the creation of a social network around improving health conditions.

As with other social networks, the ease of use of the presently described social engagement engine may be improved by its configuration for use with traditional personal computers or with mobile devices, as described above. Thus, users can update their personal information, enter tracking data, and send messages or invitations from wherever it is convenient to the user, including at work, at home, or from any location with wired or wireless network access.

Further benefits of the presently disclosed system include its multi-tiered and flexible configuration, wherein members of the team can participate in any kind of challenge against any other team, wherein members of the same team can participate in different challenges, wherein users can leave a team, join another team, or join multiple teams with all of their account information being transferred thereto, and wherein challenges can be tailor-made to suit the user's needs and desires for health condition improvement. Furthermore, the multi-tiered configuration allows for sub-teams within a team to compete against each other, for example, different departments or divisions within a company.

Yet a further benefit of the presently disclosed systems and methods, including the social engagement engine, is that they may be employed in connection with other health care related systems and methods in a coordinated effort to improve the overall health condition of users thereof. Suitable systems and methods may include, for example, the incentive-based, consumer-owned health care services that are disclosed in U.S. patent application Ser. No. 12/571,898 filed Oct. 1, 2009, “SYSTEM AND METHOD FOR INCENTIVE-BASED, CONSUMER-OWNED HEALTHCARE SERVICES”; U.S. Provisional Pat. App. No. 61/101889, “SYSTEM AND METHOD FOR CONSUMER-OWNED HEALTHCARE SERVICES”; U.S. Provisional Pat. App. No. 61/101885, “INDIVIDUALIZED HEALTH MANAGEMENT MAP”; and U.S. Provisional Pat. App. No. 61/101888, “SYSTEM AND METHOD FOR HEALTHCARE BASED INCENTIVES”, which were filed on Oct. 1, 2008; all of which are hereby incorporated by reference herein in their entirety.

it is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes.

Certain aspects of the embodiments described in the present disclosure may be provided as a computer program product, or software, that may include, for example, a computer-readable storage medium or a non-transitory machine-readable medium having stored thereon instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may take the form of, but is not limited to, a magnetic storage medium (e.g., floppy diskette, video cassette, and so on); optical storage medium (e.g., CD-ROM); magneto-optical storage medium; read only memory (ROM); random access memory (RAM); erasable programmable memory (e.g., EPROM and EEPROM); flash memory; and so on.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular embodiments. Functionality may be separated or combined in procedures differently in various embodiments of the disclosure or described with different terminology. Furthermore, whereas the term “incentive” as used herein makes general reference to one or more enumerated incentives, it will be appreciated that such incentive may be provided in combination, e.g., providing two or more such incentives. These and other variations, modifications, additions, and improvements may fall within the scope of the disclosure as defined in the claims that follow.

What is claimed is:

1. A computer-implemented method for operating a health program, comprising:
providing a computing system comprising a processor, a data storage medium, and software, wherein the software causes the computing system to:
form a plurality of virtual teams based on team formation data stored in the data storage medium; and
form one or more virtual challenges based on challenge formation data stored in the data storage medium;
wherein a user competes as a member of at least one of the plurality of virtual teams in the one or more virtual challenges by sending data representing a tracked health condition of the user over an electronic network to the computing system.

2. The method of claim 1, further comprising applying an algorithm to the health condition data to convert it into a score for at least one of the teams for which the user is a member.

3. The method of claim 2, further comprising transmitting, over the electronic network, the numerical score in a user-readable format.

4. The method of claim 3, wherein the numerical score is transmitted in a leaderboard format.

5. The method of claim 1, wherein the team formation data comprises team size.

6. The method of claim 1, wherein the team formation data comprises team membership format.

7. The method of claim 1, wherein the challenge formation data comprises a health condition goal.

8. The method of claim 1, wherein the challenge formation data comprises challenge participant information.

9. The method of claim 1, wherein the data representing the tracked health condition comprises the weight of the user.

10. The method of claim 1, wherein an award is provided for winning a challenge.

11. The method of claim 1, further comprising providing an interface configured to allow a user to join a team.

12. The method of claim 11, further comprising providing an interface configured to allow a user to invite another person to join a team.

13. The method of claim 11, further comprising providing an interface configure to allow a user to check the status of a challenge.

14. A computer-implemented system for operating a health program comprising a processor configured to implement:
a team formation module, wherein the team formation module is configured to receive data representing the formation of a plurality of teams and store such data in a data storage medium operably connected to the processor;
a challenge module, wherein the challenge module is configured to receive data representing the formation of one or more challenges and store such data in the data storage medium;
a data tracking module, wherein the data tracking module is configured to receive, over an electronic network, data representing a tracked health condition of a user and store such data in the data storage medium; and
a scoring module, wherein the scoring module is configured to apply an algorithm to the health condition data to convert it into a numerical score.

15. The system of claim 14, wherein at least one of the plurality of teams is formed in multi-tiered configuration that includes one or more sub-teams.

16. The system of claim 14, wherein the health condition data is generated automatically by a health condition tracking device.

17. The system of claim 14, wherein at least one or the one or more challenges comprises a weight loss goal.

18. The system of claim 14, wherein the one or more challenges comprises an exercise or activity goal.

19. The system of claim 18, wherein the one or more challenges further comprises a weight loss goal.

20. The system of claim 17, wherein the tracked data is numerical data and wherein the algorithm converts the numerical tracked data into the numerical score.

21. The system of claim 14, wherein the tracked data is qualitative data and wherein the algorithm converts the qualitative tracked data into the numerical score.

22. The system of claim 14, wherein the data representing a tracked health condition of a user is received over the electronic network from a mobile device.

23. A computer readable medium comprising computer-executable instructions configured to cause a computer to:
form a plurality of virtual teams based on team formation data stored in the data storage medium; and
form one or more virtual challenges based on challenge formation data stored in the data storage medium;
wherein a user competes as a member of at least one of the plurality of virtual teams in the one or more virtual challenges by sending data representing a tracked health condition of the user over an electronic network to the computing system.
